(19) United States
(12) Patent Application Publication
(10) Pub. No.: US 2012/0023010 A1
(43) Pub. Date: Jan. 26, 2012

(54) SYSTEM AND METHOD FOR ENCOURAGING DEPOSIT ACCOUNT BALANCE STABILITY

(75) Inventor: William FILONUK, JR., New Canaan, CT (US)

(73) Assignee: The Bank of New York Mellon, New York, NY (US)

(21) Appl. No.: 12/843,544

(22) Filed: Jul. 26, 2010

(51) Int. Cl. G06Q 30/00; G06Q 40/00

(52) U.S. Cl. 705/39

(57) ABSTRACT

Systems and methods are provided for encouraging for deposit account stability. The systems and methods may include defining rules relating to a defined account balance incentive band for a given deposit account, monitoring and store balance information in the at least one storage device, determining whether the stored balance information indicates that a balance of the at least one deposit account falls within the account balance incentive band, and determining whether to assess a penalty to a depositor associated with the deposit account based on the determination of whether the balance of the deposit account fell within the account balance incentive band.

### FIELD OF THE INVENTION

The invention relates to a computer-implemented system for providing incentives and/or disincentives that result in stability of a deposit account within a defined range.

### BACKGROUND

It has been observed that deposit account balances tend to spike near the end of their associated reporting periods. Furthermore, account balances tend to drop at the beginning of the subsequent reporting period. As such, financial institutions providing these deposit accounts are limited in their ability to invest deposits after the reporting period is over. Furthermore, as metrics relating to these deposit accounts are based on averages, quick spikes in account balances tend to create the appearance that a given financial institution has more funds to invest than are available in actuality.

Therefore, it would be advantageous to provide incentives to depositors to maintain more stable account balances throughout a given reporting period, rather than creating large balance spikes near the end of reporting periods or other periods. These and other problems exist.

### SUMMARY

The invention solving these and other problems in the field provides computer-implemented systems and methods for incentivizing deposit account stability. In some implementations, systems for incentivizing deposit account stability may include one or more computer-implemented devices (e.g., servers, desktops, workstations, laptops, mobile devices, and their associated processors) that execute or otherwise support an account stability application. The account stability application may be a computer application or suite of applications that is operated by or on behalf of (e.g., by a service provider) the financial institution. The account stability application may include one or more modules that configure the one or more processors of the computer-implemented devices to perform one or more of the features and functions described herein and/or other functions.

For example, in some implementations, the one or more modules may include a rules module that enables the creation and storage of one or more rules defining the parameters for encouraging deposit account stability. For example, in some implementations, the rules may include upper and lower account balance thresholds for a given deposit account. In some instances, the upper and lower account balance thresholds may be referred to as “ceiling” and “floor,” respectively. The balance range between the floor and the ceiling amounts may be referred to as a “band” or the “incentive band.”

In some implementations, the one or more modules may include a monitoring module that monitors deposit accounts. Such monitoring may include observing and recording the account balance of a given account at a predefined interval (e.g., every 24 hours). Monitoring may also include observing and recording the account balance of a given account when an indication of an account balance change is received or observed (e.g., the monitoring module may observe events/actions of the software applications that add funds to or withdrawal funds from accounts 117).

In some implementations, the one or more modules may include a penalty module that assesses penalties to one or more deposit accounts. For instance, when the rules module has determined that a penalty is to be applied to a given account, the penalty module may actually assess the penalty. Assessment of the penalty may include, for example: removing the amount of the penalty from the account, creating an obligation on the part of the depositor in the amount of the penalty, or otherwise assessing the penalty.

In some implementations, the one or more modules may include a rules module that awards bonuses to one or more accounts. For instance, when the rules module has determined that a bonus/reward is to be applied to a given account, the reward module may actually award the bonus. Awarding the bonus may include, for example: adding the amount of the bonus to the account, creating an obligation on the part of the financial institution to the depositor in the amount of the bonus, or otherwise awarding the bonus.

In some implementations, the invention provides one or more methods for incentivizing stable deposit account balances. Methods for incentivizing stable deposit account balances may include defining one or more rules setting forth one or more parameters for incentivizing stable deposit account balances, monitoring accounts, comparing a monitored balance to the one or more rules defined for the monitored account, determining if a penalty or reward is to be applied to an account, and/or other processes.

In some implementations, methods for incentivizing stable deposit account balances may include monitoring an account for a predetermined period of time, calculating the average balance of the account for a given reference period, calculating an incentive band for the account for the predetermined period of time using the average reference period balance, comparing the balance of the deposit account for each business day (or other period) to the calculated incentive band, assessing any penalty or bonus to the account's depositor, and/or other operations.

These and other objects, features, and advantages of the invention will be apparent from the detailed description and the attached drawings. It is understood that both the foregoing summary and the following detailed description are for exemplification of features of the invention and are not restrictive as to the scope of the invention.

### BRIEF DESCRIPTION OF THE DRAWINGS

FIG. 1 illustrates an example of an environment in which a system for encouraging deposit account balance stability can reside, according to various implementations of the invention.

FIG. 2 illustrates an example of a process for encouraging deposit account balance stability, according to various implementations of the invention.

FIG. 3 illustrates a graph of account balance levels and various thresholds of systems and methods for encouraging deposit account balance stability, according to various implementations of the invention.

FIG. 4 illustrates a graph of account balance levels and various thresholds of systems and methods for encouraging deposit account balance stability, according to various implementations of the invention.

FIG. 5 illustrates an example of a process for encouraging deposit account balance stability, according to various implementations of the invention.

### DETAILED DESCRIPTION OF THE INVENTION

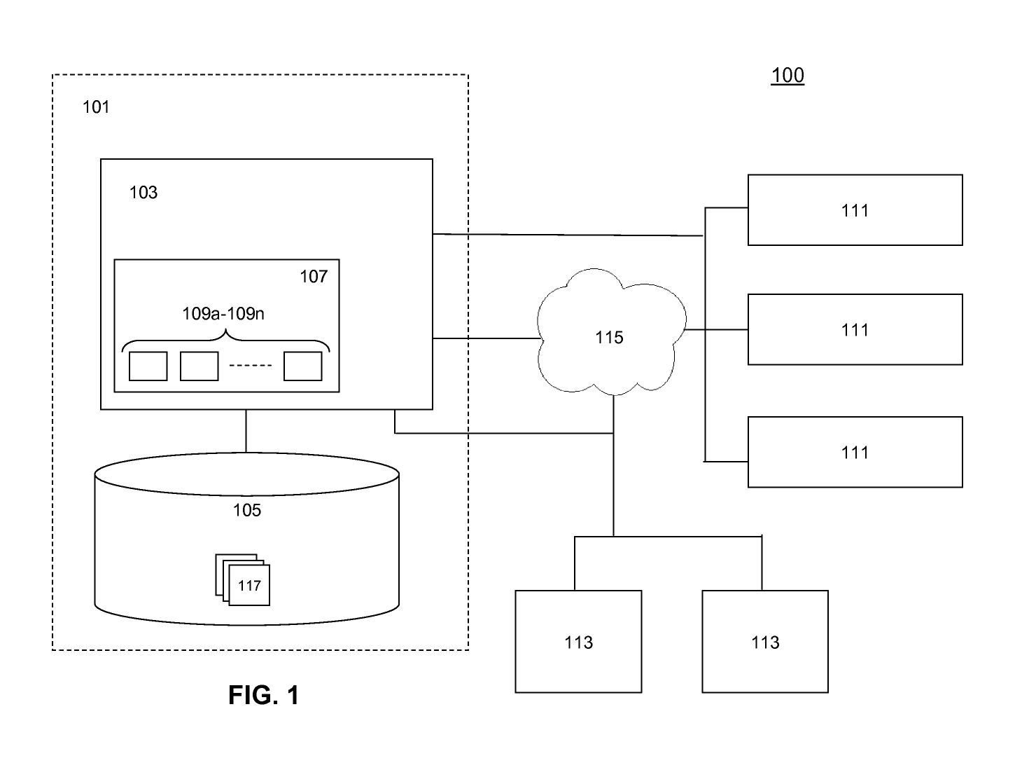

The invention provides systems and methods for incentivizing stable deposit account balances. FIG. 1 illustrates an environment 100, which is an example of an environment in which a system for incentivizing stable deposit account balance resides. Environment 100 may include a financial institution 101, which may operate or otherwise be associated with a system 103, which is an example of a system for incentivizing stability in a deposit account. Financial institution 101 may also include data store 105, which may include one or more data storage components that store information relating to deposit accounts 117 offered by/held with financial institution 101, other accounts offered by/held with financial institution 101, and/or other information utilized by financial institution 101.

In some embodiments, data storage components supporting data store 105 may include one or more data storage devices, databases, memory, and/or other devices necessary or desired for the various features or functions of the invention. Data storage components may be, include, or interface to, for example, an Oracle™ relational database sold commercially by Oracle Corporation. Other databases, such as Informix™, DB2 (Database 2) or other data storage or query formats, platforms, or resources such as OLAP (On Line Analytical Processing), SQL (Standard Language Query), a SAN (Storage Area Network), Microsoft Access™ or others may also be used, incorporated, or accessed into the invention.

System 103 may include one or more computer-implemented devices (e.g., servers, desktops, workstations, laptops, mobile devices, and their associated processors) that execute or otherwise support an account stability application 107. Account stability application 107 may be a computer application or suite of applications, that is operated by or on behalf of (e.g., by a service provider) financial institution 101. Account stability application 107 may include one or more modules 109a-109n that configure the one or more processors of the computer-implemented devices to perform one or more of the features and functions described herein and/or other functions.

In some implementations, modules 109a-109n may include computer-executable instructions embodied on computer-readable storage media such as, for example, one or more disks, tapes, non-volatile memory, hard disks, or other computer-readable storage media (e.g., magnetic media, digital media, or other media). In some implementations modules 109a-109n may be implemented across multiple applications (e.g., application 107 may include multiple applications) and/or devices to perform the features and functions described herein and/or other features and functions.

In some implementations, modules 109a-109n may include instructions causing the one or more processors of the computer-implemented devices supporting account stability application 107 to receive parameters relating to incentivizing deposit account balance stability, calculating an account balance incentive band for one or more deposit accounts, monitor one or more deposit account balances, apply monitored account balance information to parameters for incentivizing deposit account balance stability, determine one or more penalties and/or rewards for depositors of accounts, and/or to perform other features or functions.

In some implementations, some or all of modules 109a-109n may be part of or may operate in conjunction with other software operated by or for financial institution 101 such as, for example, a “Core Banking System” (e.g., SunGuard™ AMBIT™ or Wallstreet Systems™ GBS/Atlas Global Banking™). For example, in some implementations, modules 109a-109n or application 107 may be part of or may interact with software designed to manage financial institution 101's deposit accounts, other accounts, or other operations.

In some implementations, environment 100 may also include one or more depositors 111. Depositor 111, as illustrated in FIG. 1, may include a computer system of an entity (or the entity itself) that has one or more deposit accounts 117 with financial institution 101. In some instances, depositor 111 may represent the computer system of an entity (or the entity itself) acting on behalf of or as an intermediary for an entity that has a deposit account with financial institution 101. For example, an intermediary may include an agent, attorney, bank or other financial institution, or otherwise an entity having authority to act on behalf of a given depositor with respect to the depositors deposit account with financial institution 101.

In some implementations, environment 100 may include one or more outside data sources 113. Outside data sources 113, as illustrated in FIG. 1, may include a computer system of an entity (or the entity itself) that provides financial institution 101 with third-party information (i.e., information not originating from financial institution or one or more depositors 111). For example, third-party information may include information regarding interest rates, credit information (credit ratings, credit events, etc.), market volatility (e.g., such as measured by the VIX Index), and/or other information.

In some implementations, environment 100 may include a computer network 115. Computer network 115 may connect or enable interface between financial institution 101 (including system 103, data store 105, account stability application 107, and/or account information) and one or more depositors 111. In some instances, one or more depositors 111 may interface with financial institution 101 via other communication channels (e.g., traditional mail, face to face, etc.). In some implementations, all or part of account stability application 107 may be accessible as a website or one or more web pages available to depositors 111 or other parties (e.g., administrators, etc.) via computer network 115.

Third party data sources 113 may also interface with financial institution 101 (and/or system 103) via computer network 115. In some instances third-party data sources 113 may interface with financial institution 101 (and/or system 103) via other communication channels.

In some implementations, network 115 may be and/or include the Internet, an intranet, a local area network (LAN), a wide area network (WAN), or other computer network enabling communication among the various elements of environment 100 and/or other computer systems and elements. Any suitable communications link may be utilized, including any one or more of, for instance, a copper telephone line, a Digital Subscriber Line (DSL) connection, a Digital Data Service (DDS) connection, an Ethernet connection, an Integrated Services Digital Network (ISDN) line, an analog modem connection, a cable modem connection, a wireless connection, a cellular connection, a fiber-optic connection, or other connection. One or more security technologies may be used to ensure the security of information across all parts of the system, where necessary. For example Secure Socket Layer (SSL) protocol and bank level SSL may be utilized to ensure the authenticity and security of messages passed across the network.

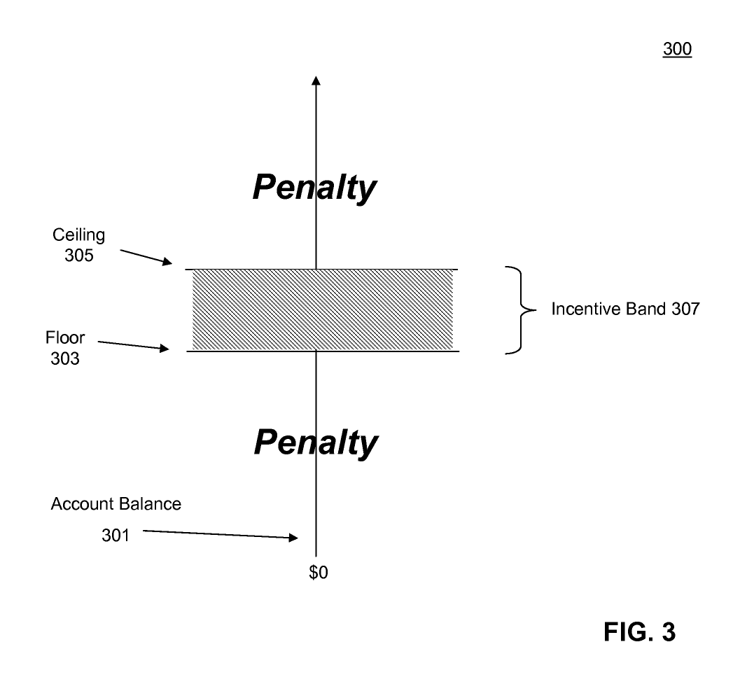

System 103 and account stability application 107 enable financial institution 101 to encourage deposit account stability. For example, in some implementations, account stability application 107 may include a rules module (e.g., one or more of modules 109a-109n) or other component that enables the creation and storage of one or more rules defining the parameters for encouraging deposit account stability. For example, in some implementations, the rules module may include or determine upper and lower account balance thresholds for a given deposit account. In some instances the upper and lower account balance thresholds may be referred to as “ceiling” and “floor,” respectively. The balance range between the floor and the ceiling amounts may be referred to as a “band” or the “incentive band.” FIG. 3 is a graph 300 that illustrates a balance amount axis 301, a floor 303, and a ceiling 305, wherein floor 303 and ceiling 305 define an incentive band 307.

In some implementations, the ceiling and/or floor balance amounts may be standard amounts applied across all accounts operating under a program of account stability encouragement (i.e., all depositors 111 operate under the same ceiling and/or floor amounts). In some implementations, the ceiling and/or floor balance amounts may be customized for one or more of the accounts 117 of one or more of the depositors 111. In some implementations, ceiling and/or floor balance amounts may be determined using one or more characteristics of a given account 117, depositor 111, and/or other factors. For example, in some implementations, the floor and ceiling balance amounts may be determined by a mathematical relationship between the interest rate offered on an account, a penalty rate, and a measure of stability of the account, and/or other parameters. In some implementations, any one or more of these parameters may be determined by a relationship to one or more of the remaining parameters. For example, a deposit with a ceiling/floor closer to the average balance over a reference period (e.g., a “tighter” or smaller incentive band) will carry a higher rate of interest due to the higher stability of the deposit. In some implementations, this account may also have a lower penalty rate as a result of the higher probability of breaching the ceiling/floor. Conversely, a deposit with a ceiling/floor further away from the average balance over a reference period may carry a lower rate of interest to due the lower stability of the deposit and may have a higher penalty rate as a result of the lower probability of breaching the ceiling/floor. In one example, with a ceiling/floor of +/−3% of the average balance over a reference period, the attached interest rate may be a market reference rate (such as fed funds) plus X basis points. An account with an incentive ceiling/floor of +/−50% of the average balance during a reference period, the interest rate may be market reference rate (such as fed funds) less X basis points.

In some implementations, the ceiling/floor, interest rate and penalty rate may also be set with reference to other indicators or parameters as starting points (i.e., in addition to, or instead of the distance of the ceiling/floor from the average). For example, the ceiling/floor may be established based on market indicators such as volatility (e.g., as measured by the VIX Index) and/or other indicators. The market indicator may be referenced on an absolute basis (e.g., a VIX level of 25) or it may be on a relative basis such as the x-day moving average crossing above or below the y day moving average (e.g., the 30 moving average of the VIX crosses above the 120 day moving average of the VIX). Note that the moving average may be a simple moving average or a weighted moving average. The adjustment may be implemented on a barrier basis, e.g., once the market indicator such as VIX breaches a certain level, the ceiling, floor, interest and penalty rates adjust once until the next reference period. The adjustment may also be implemented on a dynamic basis where the ceiling, floor, interest, and penalty rates adjust daily throughout the reference period based on the market indicator. The market indicator adjustment to the ceiling and floor may be implemented such that the ceiling and floor that are not equidistant from the average balance over the reference period. An example of a market-adjusted implementation is versus a standard equidistant from the average ceiling and floor when the 30 day moving average of the VIX crosses above the 120 day moving average, the ceiling and penalty rate are adjusted higher by x percent, and the floor and interest rate is adjusted lower by y percent where x is not necessarily equal to y. Similarly, when the 30 day moving average crosses below the 120 day moving average, the ceiling and penalty rate is adjusted lower by x percent and the floor, and interest rate is adjusted higher by y percent where x is not necessarily equal to y. Other methods of adjusting the parameters described herein may be used.

In some implementations, the ceiling and/or floor amounts may be determined retroactively, i.e., after a given period of time has expired. For example, after a given period of time (i.e., a quarter) the average balance (or other statistical benchmark) for a given account during the quarter may be used to set the ceiling and/or floor for that account for that quarter. In these retroactive calculations, a certain amount above and below (e.g., one standard deviation) the average balance may be used to set the ceiling and floor, respectively. As the floor and ceiling are determined retroactively, the consequences of holding a balance for a given period of time for that quarter that falls outside of the incentive band may be applied retroactively (e.g., for each business day the balance is outside the band, a penalty may be applied; for each business day that the balance is inside the band, a bonus may be provided).

The rules module may also enable definition and storage of incentive parameters. Incentive parameters may include defined penalties for holding an account balance above or below a defined incentive band. In some instances, the penalty definitions may specify a dollar (or other currency) amount that an account holder will be charged when the account falls outside of a defined incentive band. In some instances, the penalty definitions may also specify a threshold period of time for which the balance must be outside the incentive band for a penalty to be assessed. For example, in some instances a penalty definition may specify that a specific penalty amount is to be charged if a balance is outside the incentive band for more than 24 hours.

In some implementations, the incentive parameters may specify an interval or period to be applied to application of a penalty. For example, a 24 hour interval or period may be specified for application of a penalty to a given account for every 24 hour period that the balance is outside the incentive band. Other methods for calculating when and how often to apply a penalty may also be used. In some implementations, entry/exit points may be established wherein any penalty is waived on initial deposit and at pre-agreed times for increases or decreases from the initial deposit. Penalties may also be established for early termination of the deposit from a previously agreed term.

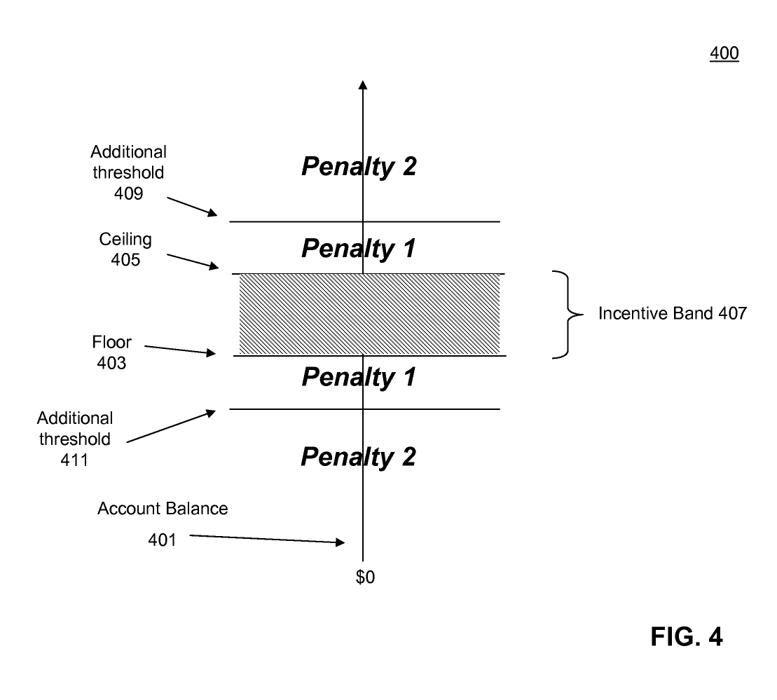

In some implementations, incentive parameters may include parameters that specify varying levels of penalties depending on the magnitude of an account balance's deviation from an incentive band. For example, the incentive parameters may define certain balance amounts outside of an incentive band that trigger additional penalties. FIG. 4 is a graph 400 that illustrates a balance amount axis 401, a floor 403, a ceiling 405, an incentive band 407, and additional thresholds 409 and 411. Using this example, if an account balance fell between ceiling 405 and additional threshold 409, a first penalty amount may be charged. If the account balance fell beyond additional threshold 409, a second (e.g., greater and/or additional) penalty may be charged. Similar penalty levels may be applied for balances falling below floor 403, additional threshold 411, etc. Although FIG. 4 illustrates two penalty levels, in some implementations more than two penalty levels may be defined.

In some implementations, incentive parameters may include payments or other rewards (or positive incentives) encouraging account holders to maintain an account balance within an incentive band. For example, rather than charging a penalty to a depositor for maintaining a balance outside of a defined incentive band, depositors may earn a bonus or payment for maintaining an account balance within an incentive band during a given period of time. Similar to the penalties discussed herein, bonuses/rewards may be associated with retroactive application, time periods (i.e., must maintain a balance within an incentive band for a specific time period to earn a bonus), intervals (i.e., a bonus is paid for each interval), and/or other incentive parameters.

In some implementations, the rules module may provide or otherwise support one or more interfaces for creation and editing of rules that define parameters for encouraging account stability. For example, the rules module and account stability application may enable a graphical user interface whereby a user or administrator may define various parameters for encouraging deposit account balance stability. Parameters that may be defined include: identification of specific accounts to which one or more rules are applicable (e.g., using account no.), floor and ceiling amounts, penalty and/or bonus amounts, time periods for determining whether a balance has stayed within or outside of an incentive band, penalty/bonus intervals (e.g., reference periods), additional thresholds, and/or other parameters. While a graphical user interface has been described for defining and editing rules and parameters, other methods of defining and editing parameters may also be used, such as, for example, uploading a structured file recognized by the rules module containing the rules/parameters.

In some implementations, account stability application 107 may also include a monitoring module (e.g., one or more of modules 109a-109n) or component that monitors accounts 117. In some implementations, the monitoring module monitors the account balances of one of more accounts 117. Such monitoring may include observing and recording the account balance of a given account at a predefined interval (e.g., every 24 hours). Monitoring may also include constant monitoring by observing and recording the account balance of a given account when an indication of an account balance change is received or observed (e.g., the monitoring module may observe events/actions of the software applications that add to or withdrawal funds from accounts 117).

In some implementations, the monitoring module may enable retroactive application of rules for providing balance stability incentives. For example, in some implementations, the monitoring module may monitor account balances in real time and create a log or other record of a given account's balance over a given period of time. That record may then be used to provide balance information for determination of any penalties or bonuses during the given period of time. In some implementations, the monitoring module may simply extract balance information from a log or record created by another module, application, or process to provide the account balance information to rules module for determination of penalties/bonuses as described herein.

The monitoring module may store information relating to account balances and/or changes therein and report the account balances to the rules module or other portion of account stability application 107. The rules module may then utilize the information relating to actual account balances to apply the rules/incentive parameters to one or more accounts. For example, the rules module may determine and/or identify floor and ceiling parameters for a given account balance and utilize the balance information obtained from the monitoring module to determine whether a penalty or bonus/reward is to be applied to the account. The rules module may also take into account any incentive parameters when determining penalties and/or bonuses for a given account.

In some implementations, account stability application 107 may also include a penalty module (e.g., one or more of modules 109a-109n) or component that assesses penalties to one or more accounts 117. For instance, when the rules module or other portion of account stability application 107 has determined that a penalty is to be applied to a given account 117, penalty module may actually assess the penalty. Assessment of the penalty may include, for example: removing the amount of the penalty from the account, creating an obligation on the part of the depositor 111 in the amount of the penalty, or otherwise assessing the penalty.

In some implementations, account stability application 107 may also include a reward module (e.g., one or more of modules 109a-109n) or component that awards bonuses to one or more accounts 117. For instance, when the rules module or other portion of account stability application 107 has determined that a bonus/reward is to be applied to a given account 117, the reward module may actually award the bonus. Awarding the bonus may include, for example: adding the amount of the bonus to the account, creating an obligation on the part of financial institution 101 to the depositor 111 in the amount of the bonus, or otherwise awarding the bonus.

As illustrated in FIG. 1, financial institution 101 may interface with outside data sources 113 to receive data relevant to its deposit accounts 117 or other information. In some instances, the data received may be data regarding interest rates (market reference rate) which is used to calculate the interest rate applied to its deposit accounts 117. In some implementations, deposit accounts that operate under the account stability incentive programs provided by account stability application 107 may receive a more favorable interest rate as incentive to operate under the account stability incentive programs. In one example, accounts operating under the account stability programs described herein may receive an interest rate based on the 90 day treasury bill rate with one or more points added. Interest rates provided to depositors may be calculated/determined using other standards/methods.

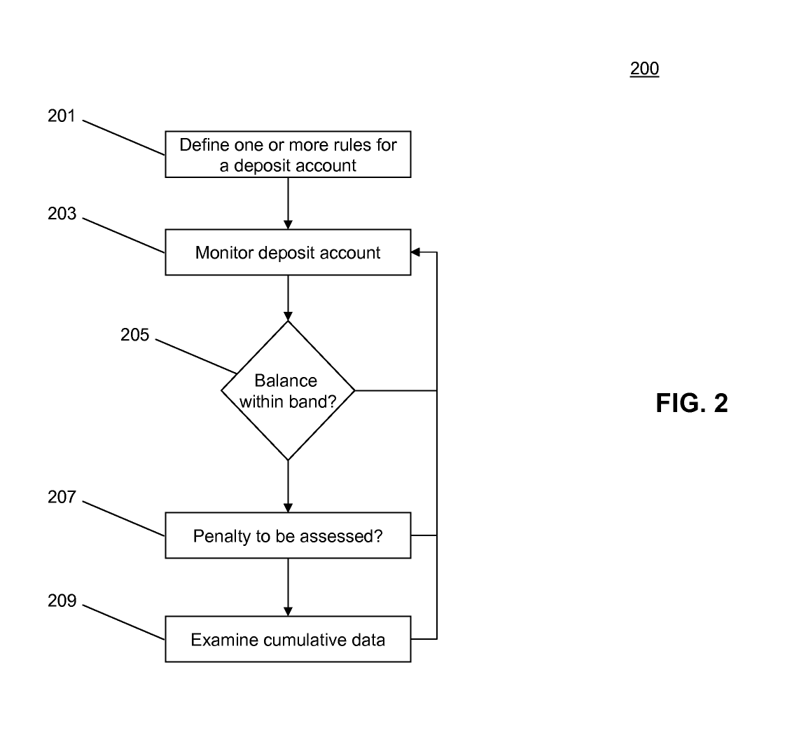

In some implementations, the invention provides a method for incentivizing stable deposit account balances. FIG. 2 illustrates a process 200, which is an example of a process for incentivizing stable deposit account balances. In some implementations, process 200 may be performed by one or more processors configured by computer executable instructions for performing a plurality of operations (e.g., the operations of process 200).

Process 200 includes an operation 201, wherein one or more rules setting forth one or more parameters for incentivizing stable deposit account balances may be defined. In some implementations, the one or more rules may be defined by a user or administrator (e.g., an employee of financial institution 101) operating at a workstation that provides a graphical user interface for defining account balance stability rules. In some implementations, the graphical user interface may be supported by a rules module or other portion of account stability application 107. In some implementations account stability application 107 may provide one or more templates from which a user can work to create one or more customized rules. In some implementations, other methods may be used to create account stability rules.

In an operation 203, the balance of a specific deposit account 117 identified by the defined rules (or otherwise identified) may be monitored. In some implementations, this monitoring may be carried out by a monitoring module or other portion of account stability application 107. In some implementations, monitoring of an account balance may be carried out according to the applicable rules or its rule parameters. For example, in some implementations, the balance of the account may be monitored multiple times daily. In some implementations, the account balance is monitored by monitoring any notices of an account balance change. Therefore, if there is no account balance change, then no notice is generated and the monitoring module operates under the assumption that the last recorded balance is the current balance.

In an operation 205, a monitored balance is compared to the one or more rules defined for the monitored account. If the monitored balance falls within an incentive band as defined by the one or more rules, this fact may be recorded (e.g., for further calculations and/or retroactive rule application). In some implementations, the rules module or other portion of account stability application 107 may make this comparison and/or perform other actions. Process 200 may then return to operation 203, wherein the account's balance is further monitored as prescribed by the one or more rules.

If the monitored balance falls outside of the defined incentive band, the one or more rules are consulted in an operation 207 to determine if a penalty is to be applied and/or what the penalty is. The determined penalty may then be applied and/or otherwise imposed on the depositor 111 associated with the monitored account. In some implementations, in an operation 209, accumulated monitoring data may be used to determine whether one or more rewards or penalties are to be assessed such as, for example, when retroactive application of the one or more rules over a period of time is used.

At any point in process 200, the process may return to operation 203 to monitor the account balance for further application to the one or more defined rules and/or for other purposes.

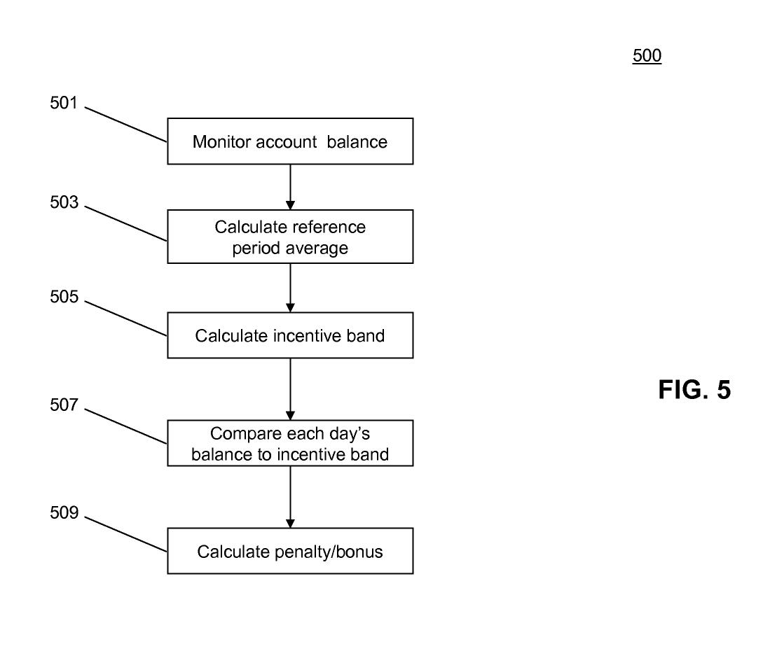

FIG. 5 illustrates a process 500, which is an example of a process for incentivizing stable deposit account balances using a retroactive application approach. Process 500 includes an operation 501, wherein the balance of a deposit account is monitored for a predetermined period of time or “reference period” (the reference period may be defined in one or more rules applied to the account). In an operation 503, at the end of the predetermined reference period, the average balance of the account during the reference period is calculated. The average reference period balance may be calculated in several ways, all of which are over the time frame of the reference period. For example one implementation may use the sum of the positive closing daily balance divided by the number of days with positive balances over the reference period. In some implementations, the average of all balances (positive, negative and zero) divided by the number of days in the reference period may be used. In some implementations, one or more forms of weighting may be used, including, for example, methodologies that give higher weights to balances close to (or on) the end of the reference period.

In an operation 505, an incentive band is calculated for the account for that predetermined period of time using the average reference period balance. The calculated incentive band includes a defined balance floor and a defined balance ceiling. As discussed herein, the ceiling and floor of the incentive band may be calculated by taking several factors into account such as, for example, the interest rate offered on the account, the penalty or bonus rate and/or other parameters. As also described herein, these other factors may be determined after the ceiling/floor are determined, rather than before.

In an operation 507, the balance of the deposit account for each business day (or other period) is compared to the calculated average reference period balance. In an operation 509, any penalty and/or bonus to be assessed is calculated. For example, in some implementations, for each day that the account balance was outside the incentive band, a penalty of one half of a basis point (i.e., 1/100 of a percentage point) may be charged to the depositor of the account. Other penalties and/or bonuses may be calculated. The penalties and/or bonuses may be predefined (i.e., may be defined in one or more rules) and/or may be variable based on the account's balance, the incentive band, and/or other factors.

In some implementations, the invention may include a tangible computer readable storage media having computer or processor-executable instructions thereon that, when executed by one or more processing devices, may configure the one or more processing devices to perform one or more of the features and functions described herein.

Those of ordinary skill in the art will appreciate that the systems described herein are examples and that the system of the invention may include more or less of the described components/elements and that the features and functions described herein may be performed by components different from those described herein. In some implementations the functions of certain components may be combined. Those of ordinary skill in the art will also appreciate that the methods/processes described herein are examples and that methods/processes according to the invention may have more or fewer operations than described above, that the operations may be performed in a different order than described above, and/or that some features and/functions may be combined.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer-implemented system for providing incentives for deposit account stability, comprising:
one or more computer processing devices configured to:
monitor balance information for a deposit account for a predetermined period of time;
calculate, for the deposit account, an account balance incentive band;
determine, for one or more days during the predetermined period of time, whether a balance of the deposit account falls within the calculated account balance incentive band, and
determine whether to assess a penalty to a depositor associated with the deposit account based on the determination of whether a balance of the deposit account falls within the calculated account balance incentive band.

2. The system of claim 1, wherein the one or more processors configured to calculate an account balance incentive band are further configured to calculate an account balance incentive band having an incentive band floor and an incentive band ceiling, wherein when a balance of the deposit account falls below the incentive band floor the balance is considered to fall outside of the incentive band and wherein when a balance of the deposit account falls above the incentive band ceiling the balance is considered to fall outside the incentive band.

3. The system of claim 1, wherein the one or more processors configured to calculate an account balance incentive band are further configured to calculate the account balance incentive band using the balance information.

4. The system of claim 1, wherein the one or more processors configured to calculate an account balance incentive band are further configured to calculate the account balance incentive band using an average balance from the balance information.

5. The system of claim 1, wherein the one or more processors configured to determine whether a balance of the deposit account fell within the calculated account balance incentive band are further configured to determine whether at least one account balance for each day during the predetermined period of time falls within the incentive band.

6. The system of claim 5, wherein the one or more processors configured to determine whether to assess a penalty are further configured to count a number of daily balances that fall outside the incentive band during the predetermined period of time and assess a penalty for each.

7. The system of claim 1, wherein the one or more processors are further configured to determine a reward to a depositor associated with the deposit account based on the determination of whether a balance of the deposit account falls within the calculated account balance incentive band.

8. A computer-implemented method for providing incentives for deposit account stability, the method being executed by one or more processing devices of a server system configured to perform a plurality of operations comprising:
monitoring, at a server system, balance information for a deposit account for a predetermined period of time;
calculating, at the server system, an account balance incentive band for the deposit account;
determining, at the server system, for one or more days during the predetermined period of time, whether a balance of the deposit account falls within the calculated account balance incentive band, and
determining, at the server system, whether to assess a penalty to a depositor associated with the deposit account based on the determination of whether a balance of the deposit account falls within the calculated account balance incentive band.

9. The method of claim 8, wherein calculating an account balance incentive band further comprises calculating an account balance incentive band having an incentive band floor and an incentive band ceiling, wherein when a balance of the deposit account falls below the incentive band floor the balance is considered to fall outside of the incentive band and wherein when a balance of the deposit account falls above the incentive band ceiling the balance is considered to fall outside the incentive band.

10. The method of claim 8, wherein calculating an account balance incentive band further comprises calculating the account balance incentive band using the balance information.

11. The method of claim 8, wherein calculating an account balance incentive band further comprises calculating the account balance incentive band using an average balance from the balance information.

12. The method of claim 8, wherein determining whether a balance of the deposit account falls within the calculated account balance incentive band further comprises determining whether at least one account balance for each day during the predetermined period of time falls within the incentive band.

13. The method of claim 12, wherein determining whether to assess a penalty further comprises counting a number of daily balances that fall outside the incentive band during the predetermined period of time and assess a penalty for each.

14. The method of claim 8, wherein the plurality of operations further comprise determining a reward to a depositor associated with the deposit account based on the determination of whether a balance of the deposit account falls within the calculated account balance incentive band.

15. A computer-implemented system for providing incentives for deposit account stability, comprising:
at least one storage device that stores balance information relating to at least one deposit account
one or more computer processing devices configured to:
receive rules information relating to providing balance stability for the at least one deposit account, the rules information including information relating to an account balance incentive band,
monitor and store balance information in the at least one storage device,
determine whether the stored balance information indicates that a balance of the at least one deposit account falls within the account balance incentive band, and
determine whether to assess a penalty to a depositor associated with the deposit account based on the determination of whether the balance of the deposit account fell within the account balance incentive band.
